(19) United States
(12) Patent Application Publication
(10) Pub. No.: US 2013/0245798 A1
(43) Pub. Date: Sep. 19, 2013

(54) Method and apparatus for signal processing based upon characteristics of music

(71) Applicants: Chris Kallai, Santa Barbara, CA (US); Michael Darrell Andrew Ericson, Santa Barbara, CA (US)

(72) Inventors: Chris Kallai, Santa Barbara, CA (US); Michael Darrell Andrew Ericson, Santa Barbara, CA (US)

(73) Assignee: Sonos, Inc.

(21) Appl. No.: 12/760,707

(22) Filed: Apr. 15, 2010

(51) Int. Cl. G06F 17/00; G06F 3/048

(52) U.S. Cl. 700/94; 715/716

(57) ABSTRACT

Techniques pertaining to enhancing acoustic effects of music playing through digital signal processing are disclosed. Genre, or style, of music embedded in a music file is received and identified in a digital signal processor (DSP). Based on the music genre, an equalization processing unit in the DSP processes the audio data stream in the music file through an equalization profile selected from a collection of sound equalization profiles preloaded in a memory unit. Each equalization profile contains digital algorithms specifically designed to boost or attenuate audio signals at certain frequency ranges in the audio frequency spectrum according to the characteristics of the style of the music. The equalization-processed audio data stream is then played in an audio playback system with an acoustic enhancement that closely reflects the nature and characteristics of the style of the music.

### BACKGROUND OF THE INVENTION

1. Field of the Invention

The present invention generally relates to the area of signal processing, and more particularly, relates to techniques for automatic audio equalization in a media playback system according to the genre of the music.

2. Description of Related Art

To enhance the listening quality of a piece of music playing in a radio or in other audio playback devices, a process called equalization is commonly used. Generally speaking, an equalization process is by passing the audio signals through a specific set of filters constructed from passive and/or active electronic elements or digital algorithms to boost or attenuate the signals of certain frequency ranges in the signal spectrum to meet the preference of a listener.

There are many kinds of equalizer. Each has a different spectrum pattern of attenuation or boost. A peaking equalizer specifies a bell shape frequency response curve around a central frequency. Shelving-type equalizers increase or attenuate the level of a wide range of frequencies by a fixed amount. A low shelf affects low frequencies up to a set point and any frequencies above that point would have little effect. A high shelf affects the high frequencies, while the frequencies below a set point are unaffected. The parameters that control the equalization are gain, usually in the unit of decibel (dB), bandwidth and a central frequency. A user may adjust one or more of these parameters to determine the overall shape of a transfer function of the filter.

An equalizer is generally used to improve the quality of sound, or the acoustic effects of a piece of music. An audio equalization may be set by a simple two-band equalizer, such as those normally used in a car audio system controlled by a treble knob for high frequencies and a bass knob for low frequencies equalizations; or it maybe set by a multi-band equalizer, for example, a graphic equalizer, in which the audio frequency spectrum is broken into several consecutive bands, and each band is controlled separately.

Equalization may also be applied to digital music. Instead of using passive and active components, digital filters can be designed and constructed using logic components and/or digital algorithms to achieve desired transfer functions for specific frequency responses and create desired acoustic effects.

With advancements in networking and data communication technologies, listening to music is no longer limited to play back recorded media or listen to local stations. For example, eliminating the geographical barriers, a satellite radio can receive signals from stations almost everywhere in the world; online music services offer streaming on-demand access to a large library of digital music through the Internet connections around the globe. The limitation of distance in music broadcasting is almost in non-existence today in the online services. Music playing systems or products designed to receive satellite radio signals or access online music services are becoming very popular. These systems and products are generally just a playback system. Some may be equipped with some types of standard sound equalization unit, or accompany a graphic equalizer that requires a user to manually adjust the equalization to meet their preference of music listening.

To esthetically appreciate a piece of music, each style of music may be enhanced by applying a specific sound equalization profile tailored according to its particular musical characteristics to its audio signals. For example, the low and high frequencies of heavy-metal rock music may be boosted to enhance the characteristics of the music; the mid-band frequencies of a vocal voice may be boosted to reproduce the fidelity of the singing in an opera. The standard sound equalization or manually adjusted equalizer in the current playback system for online music is either unable to closely reflect the characteristics of the style of music played, or required the listener to constantly adjusting or selecting proper equalization settings. Thus, there is a need for techniques to automatically apply a appropriate equalizations to enhance a piece of music based on the style of the music.

### SUMMARY OF THE INVENTION

This section is for the purpose of summarizing some aspects of the present invention and to briefly introduce some preferred embodiments. Simplifications or omissions in this section as well as in the abstract or the title of this description may be made to avoid obscuring the purpose of this section, the abstract and the title. Such simplifications or omissions are not intended to limit the scope of the present invention.

In general, the present invention pertains to techniques of enhancing acoustic effects of music playing through digital signal processing in a music playback system. When a user of a music system selects a music track from an online music service, a music file is streaming to the system. Prior to the music being played back, a digital signal processor in a music playing system automatically adjusts the equalization of the sound depending on the genre, or style, of music. A large number of sound equalization profiles are preloaded in the music playing system. Each of these profiles contains digital algorithms to boost or attenuate signals in specific frequency ranges according to genre of the music. The applying of the equalization to the music requires no user intervention. The music system would function just like an analog stereo system does where the user selects a preset equalization profile, such as Jazz, Rock or Country, except, it would be fully digital and automated.

According to one aspect of the invention, a digital signal processor receives a music file containing an audio data stream and a metadata file. Genre of music in the metadata file is extracted and style of music is identified in a process control unit. An equalization profile is selected from a preloaded collection of sound equalization profiles depending on the genre of music. The audio data stream is enhanced according to the digital algorithms in selected equalization profile. The enhanced audio data when played will closely reflect the characteristics of the style of the music.

The present invention may be implemented in many forms including a method, a system, an apparatus or a part of a system. According to one embodiment, the present invention is a method for digital processing music file through automatic sound equalization, the method comprising: receiving a streaming music file; determining whether there is a metadata file embedded in the streaming music file; extracting the metadata file from the streaming music file when a metadata file is indeed detected; buffering audio data in the streaming music file in a memory buffer; identifying data representing a genre, or style, of music from the metadata file; selecting an equalization profile from a preloaded collection of sound equalization profiles stored in a memory unit based on the genre of music identified; and releasing the audio data from the memory buffer and processing the audio data through the equalization process defined by the selected equalization profile.

According to another embodiment, the invention is a digital signal processing device for enhancing music playing back, the device comprising: a memory unit for data and code storage preloaded with a collection of sound equalization profiles; a receiver process control unit, coupled to the memory unit, configured to perform following operations: receiving a streaming music file; detecting whether a metadata file is embedded in the streaming music file; extracting the metadata file if an embedded metadata file is indeed detected; buffering audio data of the streaming music file into a memory buffer; and releasing the audio data buffered in the memory buffer for processing after an equalization profile is selected; a music genre discretion unit, coupled to the receiver process control unit, configured to identify a genre of music in the metadata file; and an equalization processing unit, coupled to the memory unit, the receiver process control unit and the music genre discretion unit, configured to select an equalization profile from the collection of sound equalization profiles stored in the memory unit and process audio data according to digital filter algorithms contained in the selected equalization profile.

Other objects, features, and advantages of the present invention will become apparent upon examining the following detailed description of an embodiment thereof, taken in conjunction with the attached drawings.

### BRIEF DESCRIPTION OF THE DRAWINGS

These and other features, aspects, and advantages of the present invention will become better understood with regard to the following description, appended claims, and accompanying drawings where:

FIG. 1 shows an operation process flow in which the present invention may be practiced;

FIG. 2 shows an exemplary functional block diagram of a digital signal processor for automatic sound equalization;

FIG. 3 shows another exemplary functional block diagram of a digital signal processor for automatic sound equalization with an input interface;

FIG. 4 is a flow chart showing a method for automatic audio signal processing to enhancing music playing based upon genre of music; and

FIG. 5 shows another exemplary functional block diagram of a digital signal processor for automatic sound equalization with graphic displaying function.

### DETAILED DESCRIPTION OF THE INVENTION

The detailed description of the invention is presented largely in terms of procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art.

Numerous specific details are set forth in order to provide a thorough understanding of the present invention. However, it will become obvious to those skilled in the art that the present invention may be practiced without these specific details. In other instances, well known methods, procedures, components, and circuitry have not been described in detail to avoid unnecessarily obscuring aspects of the present invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

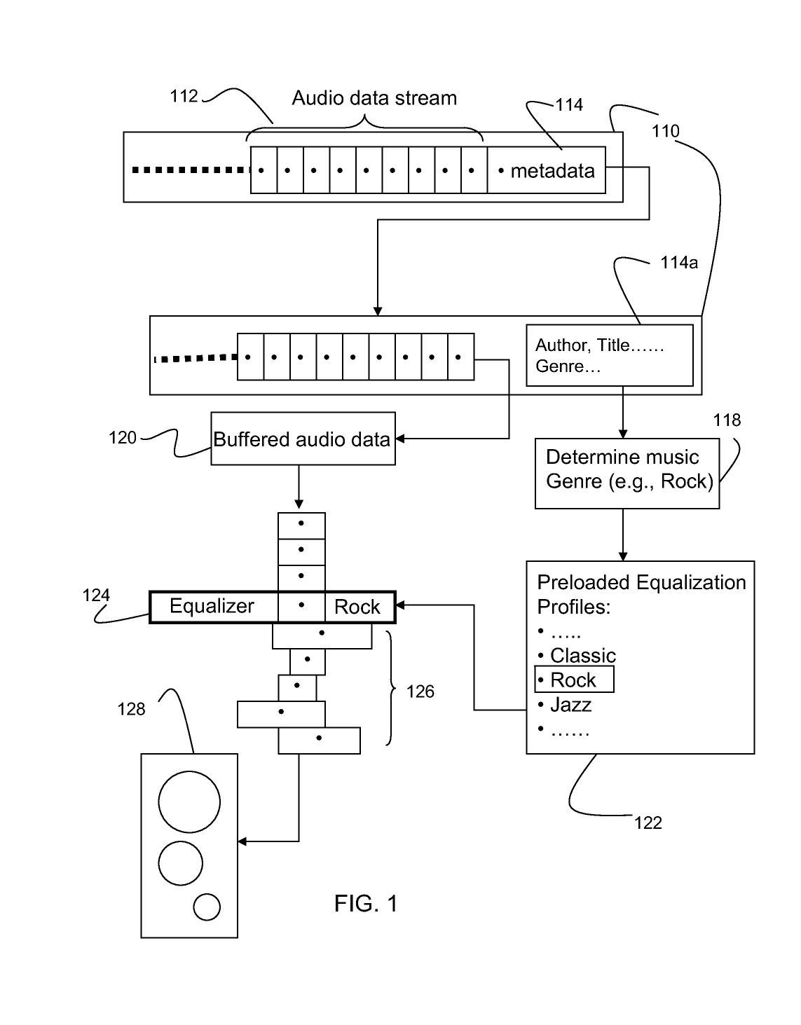

Referring now to the drawings, in which like numerals refer to like parts throughout the several views. To facilitate the understanding of an aspect of the invention, a process flow chart is shown in FIG. 1. When a user selects a song or a piece of music from an online music service or from an Internet broadcasting station, a playback system fetches a music file 110 from a network. Besides the audio data stream 112 for music playing, the music file from the online music service usually includes a metadata file 114, in which information about the music, such as title and author, is stored. An audio playback system displays this information to assist a user identifying and selecting a piece of music. The metadata file also contains a piece of information about genre, or style, of the music, for example, Classic music, Jazz, etc. A digital signal processor (DSP) in the playback system extracts the contents of the metadata file, determines the genre of the music (e.g., Rock), and delays, or buffers, the audio data stream for later processes. Based on the music genre in the metadata file, a sound equalization profile is selected from a preloaded collection of equalization profiles 122.

Each equalization profile contains digital filtering algorithms to enhance or attenuate signals at specific frequency ranges. In this example, an equalization profile tailored for Rock music is selected. With the equalization profile 124 chosen, the buffered audio data 120 is then released and streaming through an equalization process defined by the selected equalization profile 124. Consequently, an acoustically enhanced audio data stream 126 with a frequency spectrum closely reflecting the characteristics of the music, (e.g., Rock music), is generated and available for playing back. There is no user intervention required in the entire processes of enhancing the selected music. When the user selects another style of music, the DSP detects the music genre from the music file metadata and automatically selects an equalization profile corresponding to that style of music, and enhances it accordingly.

Methods of constructing digital filters for the equalization profiles are known to those skilled in the art and will not be described herein to obstruct aspects of the invention.

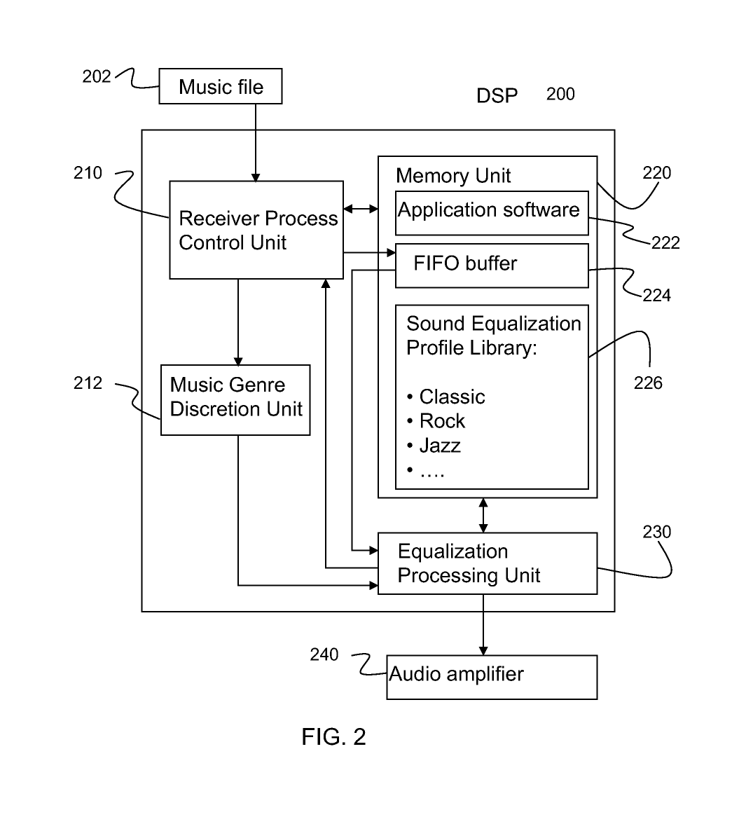

FIG. 2 shows an exemplary functional block diagram of a digital signal processor (DSP) in accordance with one embodiment of the present invention. The DSP unit 200 comprises a receiver process control unit 210, a memory unit 220, a music genre discretion unit 212 and an equalization processing unit 230. After receiving a music file 202 from a network, the receiver process control unit 210 executes application software stored in the memory unit 220 to detect and extract a metadata file from the music file. The metadata file is then transmitted to a genre discretion unit 212, where the genre of the music is detected and identified. The streaming audio data is delayed or buffered into a first-in-first-out (FIFO) memory buffer 224 in the memory unit 220 for later processing. The genre discretion unit 212 determines the style of the music and communicates this information 214 to an equalization processing unit 230. Based on the genre of the music, the equalization processing unit 230 selects a matching equalization profile from a preloaded collection of sound equalization profile 226 residing in the memory unit 220. Digital filtering algorithms in the selected equalization profile are activated and the equalization processing unit 230 notifies the receiver process control unit 210. Once acknowledged about the readiness of the selection of equalization profile, the receiver process control unit 210 releases the delayed or buffered audio data from the FIFO memory buffer 224 to the equalization processing unit 230 where the audio data is enhanced according to the digital filtering algorithms contained in the selected preloaded equalization profile. The enhance audio data stream is transmitted to audio amplifiers 240 for music playing.

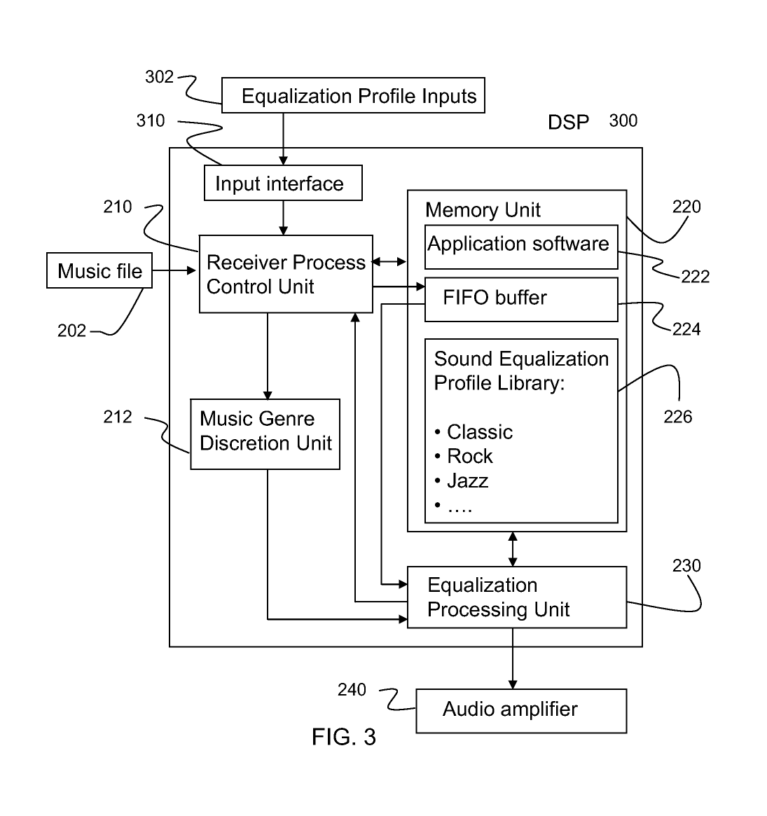

FIG. 3 shows another embodiment of the invention. DSP 200 is further comprising an input interface 310 for taking equalization profile inputs 302. Through the input interface 310, a user may upload customized equalization profiles to the preloaded collection of sound equalization profiles 226, or change the existing equalization profiles by editing the digital filtering algorithms. The input interface 310 may also serve as a firmware upgrade interface when new equalization profiles are available for downloading from a provider. The input interface 310 may be communicated through a wireless communication protocol (such as the wireless standard IEEE 802.11a, 802.11b or 802.11g), or be interfaced by a wired means (e.g., an Ethernet cable).

Depending on an exact implementation, the music genre discretion unit 212 and/or the equalization processing unit 230 may be implemented within the receiver process control unit 210, or as a combination of hardware and software. The audio amplifier 240 is typically an analog circuit that includes a D/A circuitry to convert the enhanced audio signals and to drive one or more speakers.

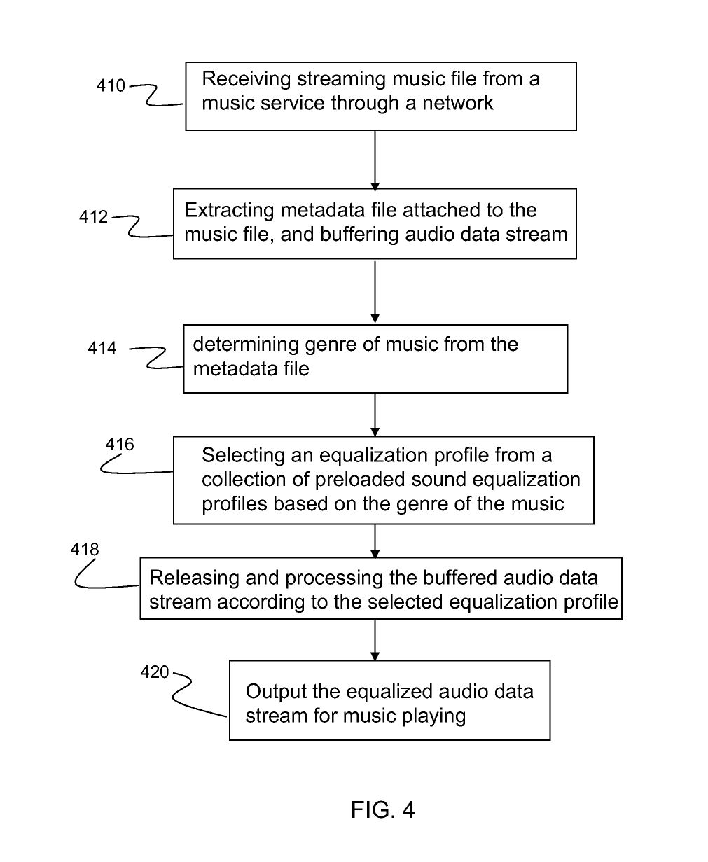

FIG. 4 shows a process or flowchart of signal processing based on genre of music in one embodiment of the present invention. Referring to FIG. 4, the process 400 begins at 410 with a DSP receiving through a network a music file containing streaming audio data and a metadata file. At 412, the DSP detects and extracts the embedded metadata file, which contains data representing genre of music, from the music file and delays or buffers the audio data to a memory buffer. Once the metadata is detected, at 414, a processing unit in the DSP interprets the data representing the genre of music and determines what style of music the buffered audio data is. Based on the genre of music, at 416, an equalization unit in the DSP selects an equalization profile from a preloaded collection of sound equalization profiles stored in a memory unit. The preloaded sound equalization profiles contain various digital filtering algorithms designed based on the characteristics of each style of music to boost or attenuate signals in specific frequency ranges. After the equalization profile is selected, at 418, the buffered audio data is released for equalization process. Consequently, a stream of enhanced audio data is automatically generated and transmitted for playing in an audio playback system, as shown in step 420.

In an event that no metadata file is detected, the DSP may use a default equalization profile or choose to bypass equalization processes and transmit the audio data stream for direct music playing. According to another embodiment, an equalization process is configured to process a music file or a streaming audio nonlinearly in a senses that the reproduction of such music fits a listening habit of a user. For example, a dynamic range of a classical music can be nonlinearly processed to make it better for old people with reduced hearing to be able to hear the quiet parts of the track. Likewise, by adjusting the phase response of the linear filters, or adding reverberation to a sound truck, one may listen to widened “Live Performances”.

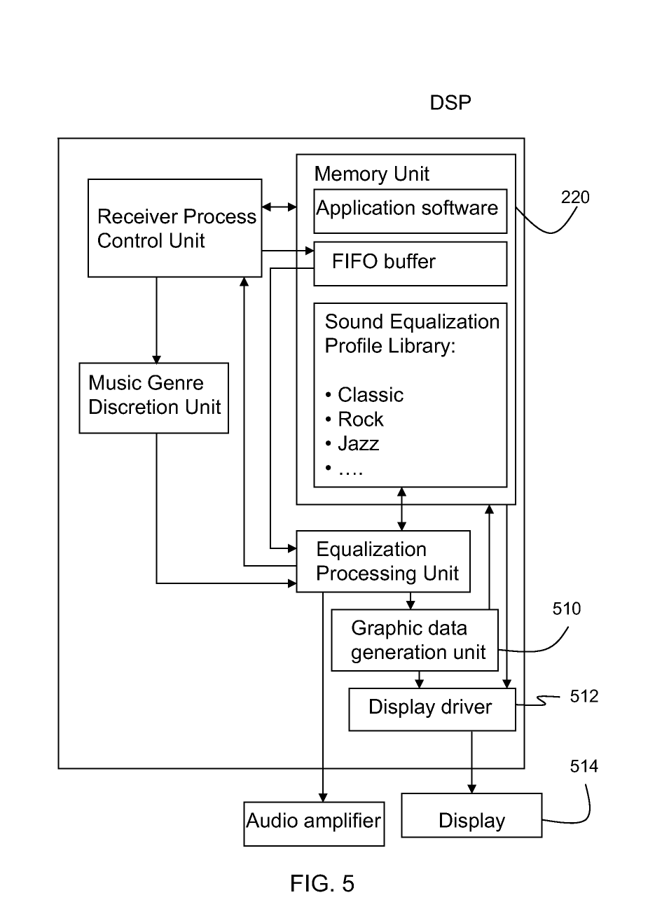

FIG. 5 shows another embodiment of the invention. The DSP includes a graphic data generation unit 510, which converts the selected equalization profile into a displayable graphic format. The graphic data representing the equalization profile may be stored in the memory unit 220 or transmitted to a display driver 512 for displaying a sound equalization curve of the selected equalization profile on a display in a playback system, if a displaying screen is so equipped in the system.

While the present invention has been described with reference to specific embodiments, the description is illustrative of the invention and is not to be construed as limiting the invention. Various modifications to the present invention can be made to the preferred embodiments by those skilled in the art without departing from the true spirit and scope of the invention. For example, an audio signal may be enhanced in some or all of its phases, magnitudes or frequencies, linearly or nonlinearly, largely depending on the listening habit of a user or the style of the music using one embodiment of the present invention. Accordingly, the scope of the present invention is defined by the appended claims rather than the forgoing description of embodiments.

1. A method for digital processing music file through automatic sound equalization, the method comprising:
receiving a streaming music file;
determining whether there is a metadata file embedded in the streaming music file;
extracting the metadata file from the streaming music file when a metadata file is indeed detected;
buffering audio data in the streaming music file in a memory buffer;
identifying data representing a genre, or style, of music from the metadata file;
selecting an equalization profile from a preloaded collection of sound equalization profiles stored in a memory unit based on the genre of music identified, the collection of sound equalization profiles expandable to include customized equalization profiles added by a user and equalization profiles downloaded from a provider; and
releasing the audio data from the memory buffer and processing the audio data through the equalization process defined by the selected equalization profile.

2. The method according to claim 1, further comprising:
receiving inputs of new equalization profiles through an input interface; and
storing the new equalization profiles in the collection of preloaded sound equalization profiles.

3. The method according to claim 2, wherein the input interface is capable of communicating through a wireless protocol or through wired means.

4. The method according to claim 1, further comprising:
generating graphic image data representing the equalization profiles;
storing the graphic image data in the memory unit in a digital signal processor (DSP); and
displaying a graphic image representing the selected equalization profile on a display screen.

5. The method according to claim 1, wherein the streaming music file is from the Internet or a local area network.

6. A digital signal processing device for enhancing music playing back, the device comprising:
a memory unit for data and code storage preloaded with a collection of sound equalization profiles;
a receiver process control unit, coupled to the memory unit, configured to perform following operations:
receiving a streaming music file;
detecting whether a metadata file is embedded in the streaming music file;
extracting the metadata file if an embedded metadata file is indeed detected;
buffering audio data of the streaming music file into a memory buffer; and
releasing the audio data buffered in the memory buffer for processing after an equalization profile is selected;
a music genre discretion unit, coupled to the receiver process control unit, configured to identify a genre of music in the metadata file; and
an equalization processing unit, coupled to the memory unit, the receiver process control unit and the music genre discretion unit, configured to select an equalization profile from the preloaded collection of sound equalization profiles stored in the memory unit and process audio data according to digital filter algorithms contained in the selected equalization profile, the equalization processing unit configured to manage the collection of sound equalization profiles to include customized equalization profiles added by a user and equalization profiles downloaded from a provider.

7. The device according to claim 6 further comprising an input interface unit coupled to the receiver process control unit configured to receive new sound equalization profiles.

8. The device according to claim 7, wherein the receiver process control unit is further configured to store the new sound equalization profiles in the preloaded collection of sound equalization profiles.

9. The device according to claim 7, wherein the input interface unit is capable of communicating through the Internet or a local area network (LAN).

10. The system device according to claim 9, wherein the LAN is a wireless network, a wired network or a combination of both.

11. The device according to claim 6, further comprising:
a graphic data generation unit coupled to the memory unit and the equalization processing unit to produce graphic data representing the selected equalization profile; and
a display driver unit coupled to the receiver process control unit and the graphic data generation unit to display an image or graph of the selected equalization profile on a display screen in a playback system.

12. The system according to claim 6, wherein the streaming music file is from the Internet or the LAN.

13. The method according to claim 1, wherein the method is executed using a digital signal processor (DSP).

14. The method according to claim 1, wherein the selected equalization profile is to configure processing of the audio data through the equalization process nonlinearly to amplify certain parts of the audio data and not amplify certain other parts of the audio data.

15. The device according to claim 6, wherein the selected equalization profile is to configure the equalization processing unit to process the audio data nonlinearly according to digital filter algorithms to amplify certain parts of the audio data and not amplify certain other parts of the audio data.
